(19) United States
(12) Patent Application Publication
(10) Pub. No.: US 2011/0238661 A1
(43) Pub. Date: Sep. 29, 2011

(54) Information processing device, content displaying method, and computer program

(75) Inventor: Hiromichi Goto, Tokyo (JP)

(73) Assignee: Sony Corporation, Tokyo (JP)

(21) Appl. No.: 13/065,138

(22) Filed: Mar. 15, 2011

(30) Foreign Application Priority Data
Mar. 29, 2010 (JP) P2010-075337

(51) Int. Cl. G06F 17/30

(52) U.S. Cl. 707/728; 707/722; 707/E17.014

(57) ABSTRACT

An image processing device may comprise a display control unit. The display control unit may control display on a display screen, around a search term, of a search result obtained from searching using the search term and at least one term related to the search term.

This application claims priority from Japanese Patent Application No. 2010-75337 filed in the Japan Patent Office on Mar. 29, 2010, the entire content of which is hereby incorporated by reference.

### BACKGROUND

1. Technical Field

The present disclosure relates to an information processing device, a content displaying method, and a computer program.

2. Description of the Related Art

Many techniques for saving a large amount of moving image contents such as television program are being proposed with increase in the capacity of a storage device capable of saving various types of information. In recent years, especially, a technique capable of automatically recording the moving image content based on a keyword specified in advance by the user, preference of the user, and the like without having the user particularly instruct recording is proposed, and many products loaded with such technique are being released.

If the moving image contents can be saved in a large amount, it becomes difficult for the user himself/herself to fully grasp what kinds of moving image contents are recorded. Therefore, a technique of searching for the moving image content desired by the user from the moving image contents saved in a large amount, and displaying the same on a screen is proposed (see e.g., Japanese Patent Application Laid-Open Nos. 2006-115052 and 2009-4892).

Japanese Patent Application Laid-Open No. 2006-115052 discloses a technique of searching for the moving image content that conforms to the keyword input by the user using caption information given to the content. Japanese Patent Application Laid-Open No. 2009-4872 discloses a technique of recording one-segment (1 segment) broadcasting of terrestrial digital broadcasting along with caption data, searching for the caption data that conforms to the keyword input by the user, and reproducing the recorded data from the area that contains the relevant caption data.

However, Japanese Patent Application Laid-Open No. 2006-115052 does not disclose on how to display the moving image content that conforms to the keyword input by the user. Similarly, Japanese Patent Application Laid-Open No. 2009-4872 relates to a technique of creating a search index from the caption data of the one-segment broadcasting and reproducing from the position desired to be viewed, but does not disclose on how to display the moving image contents on the screen when the moving image content that conforms to the search result exists in plurality or when the moving image content that conforms to a plurality of search results exists.

The moving image content saved in a large amount may not be efficiently previewed by simply displaying the search result of the moving image content on the screen, and a devisal on displaying the search result is desired. In other words, the moving image contents saved in a large amount can be efficiently previewed by making a devisal in displaying the search result of the moving image content, and furthermore, the user may make a new discovery by visually providing the relevance between the keyword and the moving image content.

In light of the foregoing, it is desirable to provide a novel and improved information processing device, content displaying method, and computer program capable of providing efficient preview of the moving image content by visually displaying the search result with respect to the moving image content along with the keyword related to the search condition.

### SUMMARY

In accordance with one aspect of the embodiments, an image processing device may include a display control unit to control display on a display screen, around a search term, of a search result obtained from searching using the search term and at least one term related to the search term.

In accordance with another aspect of the embodiments, a method of information processing may include searching using a search term to obtain a search result. The method further may include controlling, by a processor, display on a display screen, around the search term, of the search result and at least one term related to the search term.

In accordance with another aspect of the embodiments, a non-transitory recording medium may be recorded with a computer-readable program executable by a computer for enabling the computer to perform information processing. The program may include the steps of searching using a search term to obtain a search result; and controlling display on a display screen, around the search term, of the search result and at least one term related to the search term.

### BRIEF DESCRIPTION OF THE DRAWINGS

FIG. 1 is an explanatory view showing a schematic configuration of a moving image search system 1;

FIG. 2 is an explanatory view showing a configuration example of an information processing device 100 according to one embodiment of the present invention and a storage device 200;

FIG. 3 is a flowchart showing the operation of the information processing device 100 according to one embodiment of the present invention;

FIG. 4 is an explanatory view showing a display example to a video output unit 160;

FIG. 5 is an explanatory view showing a display example to the video output unit 160;

FIG. 6 is a flowchart showing the operation of the information processing device 100 ,according to one embodiment of the present invention;

FIG. 7 is an explanatory view showing a display example to the video output unit 160;

FIG. 8 is an explanatory view showing a display example to the video output unit 160;

FIG. 9 is an explanatory view showing a display example to the video output unit 160;

FIG. 10 is an explanatory view showing a display example to the video output unit 160;

FIG. 11 is an explanatory view showing a display example to the video output unit 160;

FIG. 12 is an explanatory view showing a display example to the video output unit 160; and

FIG. 13 is an explanatory view showing a display example to the video output unit 160.

### DETAILED DESCRIPTION OF THE EMBODIMENTS

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. One Embodiment of Present Invention
1-1. Configuration example of entire system
1-2. Configuration Example of Information Processing Device/Storage Device
1-3. Operation of Information Processing Device

2. Conclusion

### 1. One Embodiment of Present Invention

### 1-1. Configuration Example of Entire System

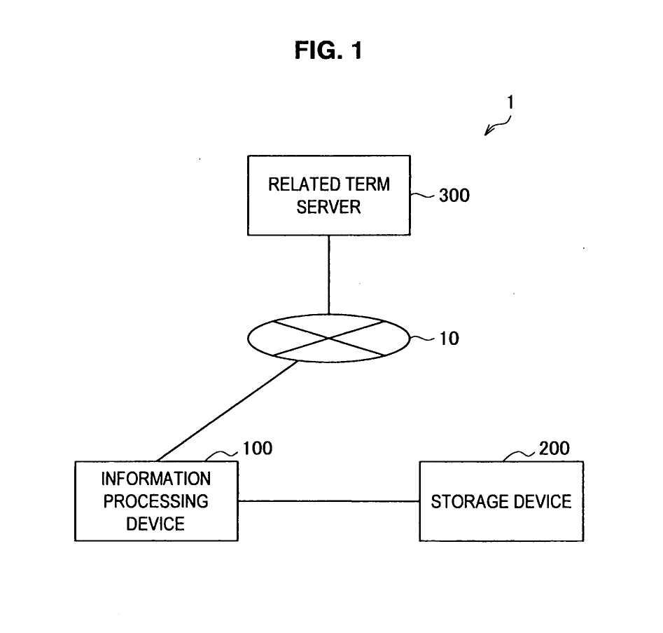

First, a schematic configuration of an entire moving image search system including an information processing device according to one embodiment of the present invention will be described. FIG. 1 is an explanatory view showing a schematic configuration of a moving image search system 1. The schematic configuration of the moving image search system 1 including the information processing device according to one embodiment of the present invention will be described below using FIG. 1.

As shown in FIG. 1, the moving image search system 1 according to one embodiment of the present invention is configured to include an information processing device 100, a storage device 200, and a related term server 300.

The information processing device 100 is a device for searching and displaying a desired moving image content from the moving image contents stored in the storage device 200. The user using the moving image search system 1 operates the information processing device 100 to input a search condition. The search condition input to the information processing device 100 by the user may be a word, a sentence, a recommended term displayed on the screen in advance, recommended category, or other information, as will be described later. The information processing device 100 extracts a moving image content, in which the search term is contained in the metadata, such as a program name, a performer, and a caption data from the moving image contents stored in the storage device 200, and displays the same on the screen. Upon displaying on the screen, the displaying is carried out such that relevance with the input search term is apparent, where a specific displaying method on the screen will be hereinafter described in detail.

The storage device 200 is a device for storing the moving image contents. In the present embodiment, the digital television broadcasting is received by the information processing device 100, and the broadcasting received by the information processing device 100 is recorded from the information processing device 100 to the storage device 200 as a moving image content in programs units or in arbitrary time units along with the program name, the program information, the caption data, and the like.

In the present embodiment, the information processing device 100 and the storage device 200 are separate devices, but the present invention is not limited to such an example. The present invention can be similarly applied even with a configuration in which the storage device is incorporated in the same device as the information processing device, and the digital television broadcasting received by the information processing device 100 is stored in the storage device. The moving image contents existing in the network 10 and downloaded and acquired by the information processing device 100 can be similarly stored in the storage device 200.

The related term server 300 is a device connected to the information processing device 100 through the network 10. The related term server 300 stores related terms in association with the relationship of a certain word and a word having relevance with the word. When searching for the moving image content, in which a certain search term is contained in the metadata, such as the program name, the performer, and the caption data, the information processing device 100 accesses the related term server 300 and also acquires information on the word related to the relevant search term. The information processing device 100 thus can display on the screen the moving image content, in which the certain search term is contained in the metadata, such as the program name, the performer, and the caption data, and also display on the screen the word related to the search term.

Therefore, with the configuration of the moving image search system 1 according to one embodiment of the present invention described above, the information processing device 100 can acquire the moving image content, in which a search term is contained in the metadata, such as the program name, the performer, and the caption data from the moving image contents stored in the storage device 200, and display/reproduce the same on the screen in a form the relevance with the search term is explicitly apparent. The information processing device 100 can acquire the moving image content from the storage device 100, and also access the related term server 300 to acquire the information on the word related to the search term and display the same. The user can visually grasp the relevance between the search term and the moving image content by having the information processing device 100 display the moving image content and the information on the word in the above manner, and furthermore, with the display of a word related to the search term on the screen, a new moving image content can be searched using such a word.

The schematic configuration of the moving image search system 1 including the information processing device according to one embodiment of the present invention has been described above using FIG. 1. A configuration example of the information processing device 100 according to one embodiment of the present invention and the storage device 200 will now be described.

### 1-2. Configuration Example of Information Processing Device/Storage Device

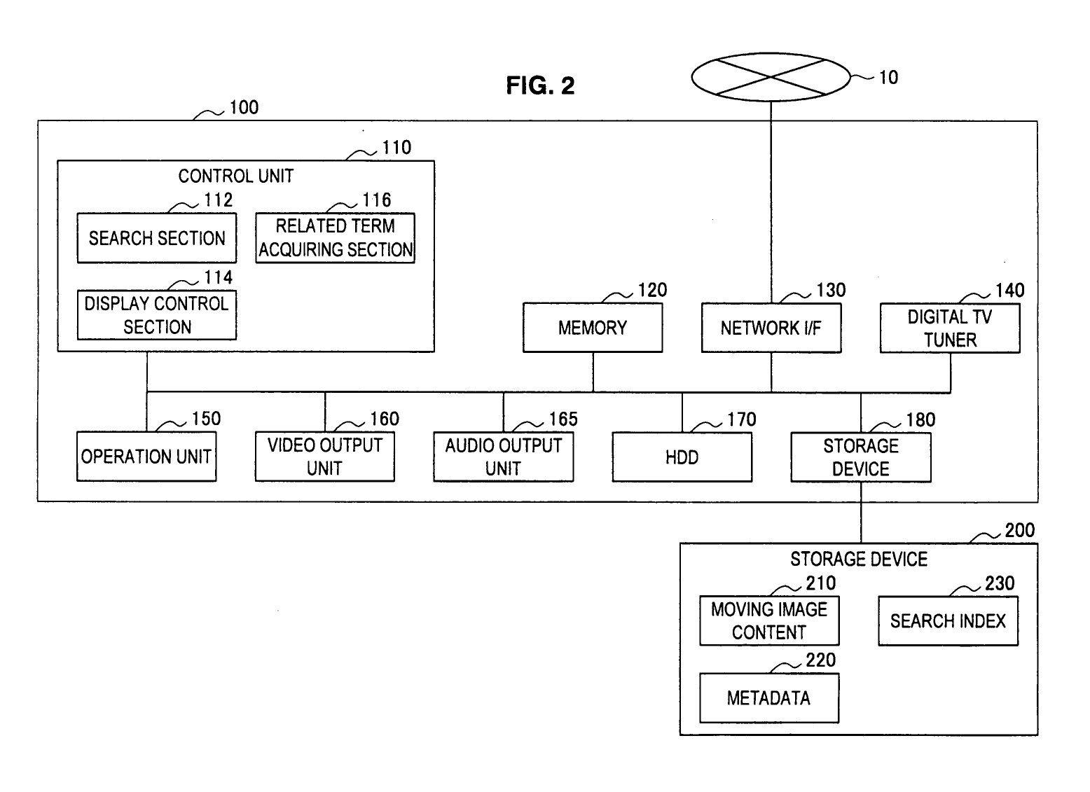

FIG. 2 is an explanatory view showing a configuration example of the information processing device 100 according to one embodiment of the present invention and the storage device 200. The configuration example of the information processing device 100 according to one embodiment of the present invention and the storage device 200 will now be described using FIG. 2.

As shown in FIG. 2, the information processing device 100 according to one embodiment of the present invention is configured to include a control unit 110 including a CPU (Central Processing Unit), a memory 120, a network interface 130, a digital TV tuner 140, an operation unit 150, a video output unit 160, an audio output unit 165, a HDD 170, and a storage device interface 180. The information processing device 100 according to one embodiment of the present invention is connected to the storage device 200 by way of the storage device interface 180.

The control unit 110 is configured by the CPU, etc., as mentioned above, and controls the operation of the information processing device 100. When the user of the information processing device 100 searches for a desired moving image content from the moving image contents saved in the storage device 200 using the information processing device 100, the control unit 110 accesses the storage device 200 and extracts the moving image content that conforms to the condition. The control unit 110 that extracted the moving image content that conforms to the condition instructs the reproduction of the extracted moving image content to the video output unit 160 and the audio output unit 165. The control unit 110 instructs the reproduction of the extracted moving image content with respect to the video output unit 160 and the audio output unit 165, and also instructs to display the search term input by the user with the video output unit 160. The user can visually grasp the relevance between the search term and the moving image content by having the control unit 110 operate in such manner.

As shown in FIG. 2, the control unit 110 is configured to include a search section 112, a display control section 114, and a related term acquiring section 116.

The search section 112 searches for and extracts the moving image content, which the user desires to preview, from the storage device 200 according to the instruction from the user. Specifically, the search section 112 searches for the moving image content, in which the search term input by the user is contained in the metadata, from the storage device 200.

The display control section 114 controls the display of video and various types of information to the video output unit 160, and the display of audio to the audio output unit 165. The display control section 114 controls the display control of the moving image content searched for and extracted from the storage device 200 by the search section 112.

The related term acquiring section 116 is connected to the related term server 300, and acquires a word related to a certain word from the related term server 300. In the present embodiment, the related term acquiring section 116 acquires the word related to the search term input by the user from the related term server 300. The word related to the search term input by the user acquired by the related term acquiring section 116 is displayed on the video output unit 160 by the display control section 114.

The memory 120 temporarily stores programs and data at the time of the operation of the information processing device 100, and is configured by various volatile or non-volatile memories. In one embodiment, the memory 120 may be a non-transitory recording medium.

The network interface 130 is an interface for connecting to the network 10. The information processing device 100 according to the present embodiment connected to the network 10 from the control unit 110 through the network interface 130 to acquire the word related to the search term from the related term server 300 when searching for the moving image content stored in the storage device 200. The information processing device 100 may be connected to the network 10 through the network interface 130, acquire and store the moving image content existing in the network 10 to the storage device 200, and also have the moving image content existing in the network 10 as target of search.

The digital TV tuner 140 is a tuner for receiving terrestrial/BS/CS digital broadcasting. The digital broadcasting received by the digital TV tuner 140 has the video displayed by the video output unit 160 and the audio output by the audio output unit 165 according to the control of the control unit 110. The digital broadcasting received by the digital TV tuner 140 is stored in the storage device 200 by the control of the control unit 110. When storing the digital broadcasting in the storage device 200, program information including the program name, the performer, and the program content are also stored in addition to the video/audio data. If caption data exists in association with the video/audio data when saving the digital broadcasting in the storage device 200, such caption data are also stored in the storage device 200.

The digital TV tuner 140 may receive 1-segment broadcasting (one-segment broadcasting) of the terrestrial digital broadcasting.

The operation unit 150 accepts the input operation of the user, and is configured to include a keyboard or a pointing device such as a mouse. When the user of the information processing device 100 operates the operation unit 150, the information processing device 100 can execute the search process of the moving image content stored in the storage device 200.

The video output unit 160 outputs video based on the processing operation of the information processing device 100, and the audio output unit 165 outputs audio based on the processing operation of the information processing device 100. The video output unit 160 is configured with a display for displaying the video, and the audio output unit 165 is configured with a speaker etc. for outputting the audio. In the present embodiment, the video output unit 160 and the audio output unit 165 output the digital broadcasting received by the digital TV tuner 140, and output the moving image content stored in the storage device 200 according to the control of the control unit 110.

The HDD 170 is a recording medium to which various types of computer programs executed by the information processing device 100, data generated by the processing operation of the information processing device 100, and the like are stored. In one embodiment, the HDD 170 may be a non-transitory recording medium. In the present embodiment, the configuration in which the moving image content is saved in the storage device 200 that is externally attached to the information processing device 100 is adopted, but the moving image content may be stored in the recording medium arranged inside the information processing device 100, as described above.

The storage device interface 180 is an interface provided to access the storage device 200 from the information processing device 100, where the information processing device 100 and the storage device 200 are connected through the storage device interface 180.

The storage device 200 connected with the information processing device 100 through the storage device interface 180 stores the moving image content 210 in which the digital broadcasting received by the digital TV tuner 140 is saved, and the metadata 220 corresponding to each moving image content 210. The metadata 220 corresponding to each moving image content 210 contains caption data in addition to the program information such as the program name and the program content, as mentioned above, if the caption data exists in association with the video/audio data.

The storage device 200 also stores a search index 230 for enabling the search process using the metadata 220 to be carried out at high speed. For instance, the search index 230 is created from the metadata 220 by the control unit 110 of the information processing device 100. Various techniques can be used for the process of creating the search index 230, and it is not limited to a specific process. For instance, the search index 230 may be created when the processing load of the control unit 110 is in a low state.

The configuration example of the information processing device 100 according to one embodiment of the present invention and the storage device 200 has been described above using FIG. 2. The operation of the information processing device 100 according to one embodiment of the present invention will now be described.

### 1-3. Operation of Information Processing Device

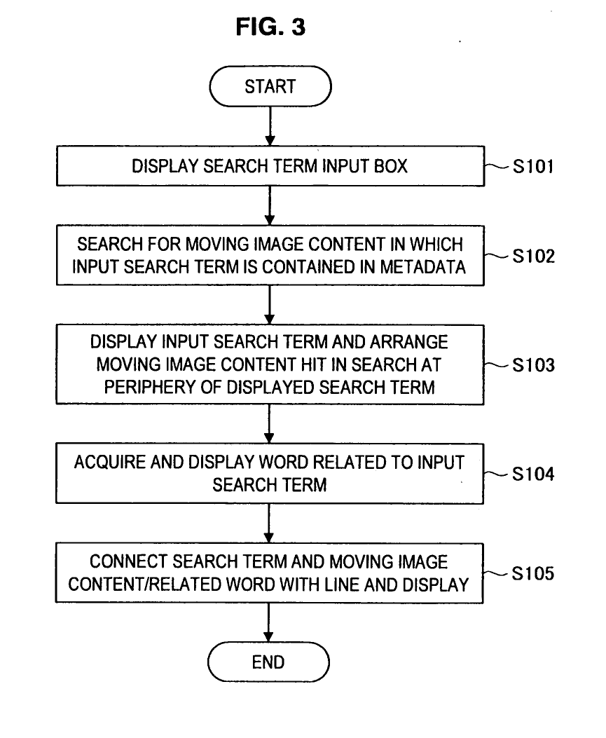

FIG. 3 is a flowchart showing the operation of the information processing device 100 according to one embodiment of the present invention. The flowchart shown in FIG. 3 shows the flow of the operation of the information processing device 100 of a case where searching for and extracting the desired moving image content from the moving image contents stored in the storage device 200 using the information processing device 100. The operation of the information processing device 100 according to one embodiment of the present invention will be described below using FIG. 3.

In order to search for and extract the desired moving image content from the moving image contents stored in the storage device 200 using the information processing device 100, an application (hereinafter also referred to as “moving image content search application”) for searching the moving image content based on the operation of the user is activated on the information processing device 100. The display control section 114 displays a search term input box on the video output unit 160 by the operation of the operation unit 150 by the user (step S101).

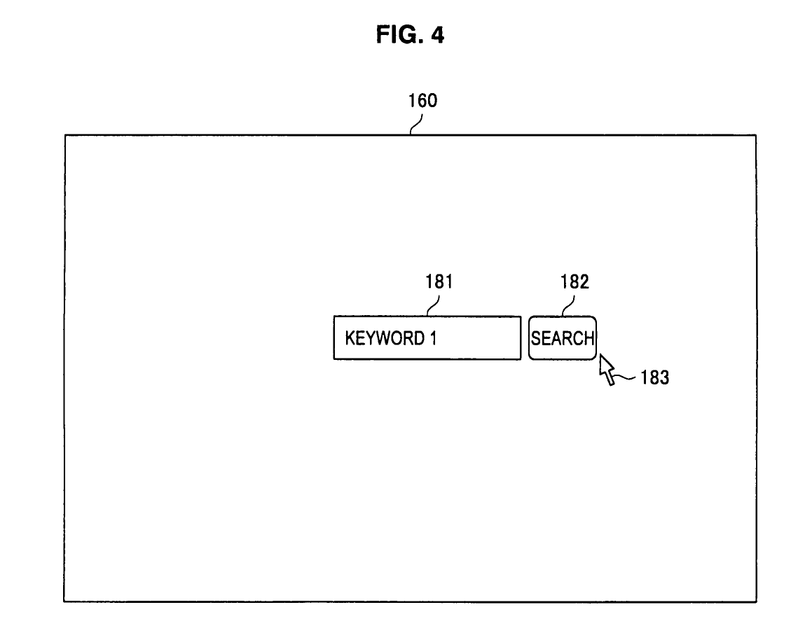

FIG. 4 shows one example of a screen displayed by the video output unit 160. FIG. 4 shows a state in which a search term input box 181 and a search button 182 are displayed on the screen when the user operates the operation unit 150 with the moving image content search application for searching the moving image content executed on the information processing device 100. To display the search term input box 181 and the search button 182 on the screen, the user may click an arbitrary place on the screen with the mouse, or the user may perform a predetermined operation on the operation unit 150. The control unit 110 that detected the user operation executes a control to display the search term input box 181 on the video output unit 160.

As shown in FIG. 4, when the search term input box 181 is displayed on the video output unit 160, the user inputs a search term in the search term input box 181, and pushes the search button 182 (e.g., clicks with the mouse) to search for the moving image content saved in the storage device 200. When the user operates the operation unit 150 to input the search term in the search term input box 181 and push the search button 182, the control unit 110 detects the pushing of the search button 182 and searches for and extracts the moving image content 210, in which the search term input to the search term input box 181 is contained in the metadata 220, from the storage device 200 (step S102).

In the example shown in FIG. 4, a state in which the user inputs “keyword 1” to the search term input box 181 as a search term, and places a mouse cursor 183 on the search button 182 and pushes the search button 182 is shown. The control unit 110 that detected the pushing of the search button 182 searches for the moving image content 210, in which the “keyword 1” input to the search term input box 181 is contained in the metadata 220, from the storage device 200. More specifically, when the control unit 110 detects the pushing of the search button 182, the search section 112 acquires the search term input to the search term input box 181, and searches for the moving image content 210, in which the relevant search term is contained in the metadata 220, from the storage device 200.

After searching for and extracting the moving image content containing the search term input to the search term input box 181 from the storage device 200, the control unit 110 displays the search term input to the search term input box 181 on the video output unit 160 and displays the moving image content extracted (hit for the search term) from the storage device 200 on the video output unit 160. More specifically, the display control section 114 controls the display on the video output unit 160 so as to arrange the extracted moving image content at the periphery of the displayed search term (step S103).

Thereafter, the control unit 110 acquires a word related to the search term input to the search term input box 181 from the related term server 300. Specifically, the related term acquiring section 116 accesses the related term server 300, and acquires the word related to the search term input to the search term input box 181 from the related term server 300. The display control section 114 also performs the control to display the word acquired from the related term server 300 on the video output unit 160 (step S104).

The display control section 114 then connects the search term displayed on the video output unit 160 in step S103, and the moving image content displayed on the video output unit 160 in step 5103 and the word displayed on the video output unit 160 in step S104 with a line, and displays the same on the video output unit 160 (Step S105). Therefore, the information processing device 100 can directly display the moving image content on the video output unit 160 without the search result screen of the moving image content. Furthermore, the information processing device 100 can visually show the user the relationship with the moving image content that hit for the search term and the word related to such search term by displaying the search term input by the user, the moving image content, in which the search term is contained in the metadata, and the word related to the search term input by the user on the video output unit 160.

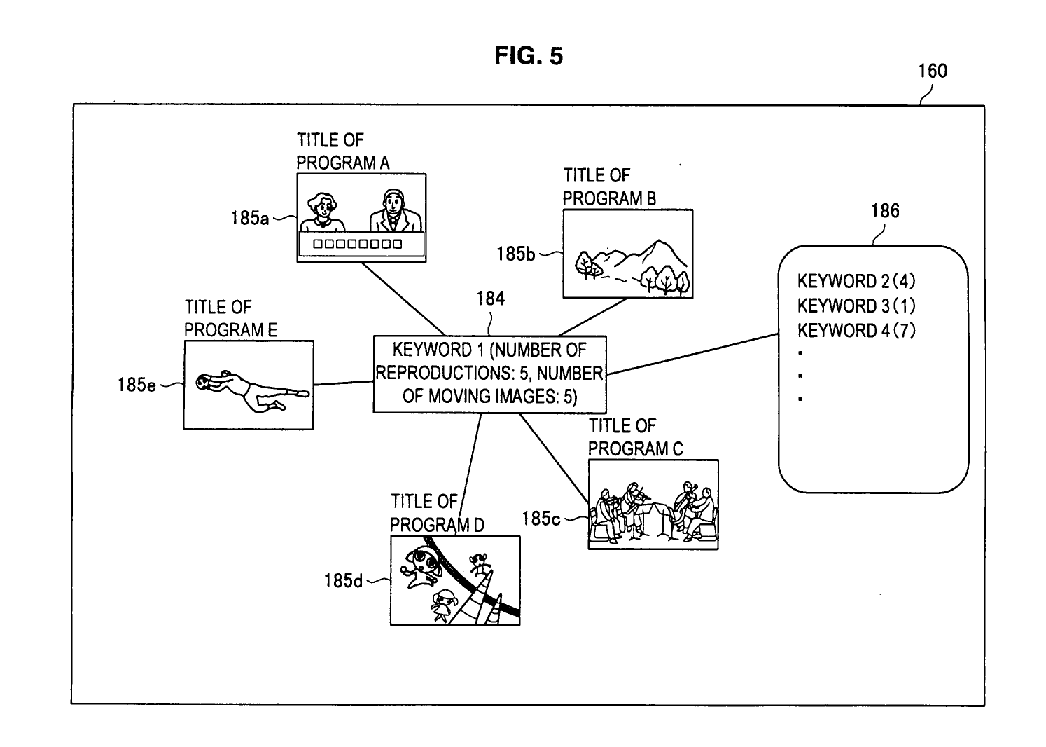

FIG. 5 shows one example of a screen displayed on the video output unit 160. FIG. 5 shows a display example of the search result of a case where the moving image content stored in the storage device 200 is searched using the information processing device 100.

In the example shown in FIG. 5, a search term display portion 184 for displaying the search term input by the user, moving image contents 185a to 185e that conform to the search term input by the user, and a related term display portion 186 for displaying a word related to the search term input by the user are displayed on the video output unit 160. Which position on the screen to display the moving image contents 185a to 185e is determined by the display control section 114 in view of the relevance with the search term, the positional relationship with the moving image content if there is a moving image content that is already displayed, and the like. If the moving image content that conforms to the search term input by the user exists in plurality in the storage device 200, the information processing device 100 simultaneously displays the plurality of moving image contents that conform to the search term on the video output unit 160 as shown in FIG. 5.

As shown in FIG. 5, the search term display portion 184 displayed on the video output unit 160 is connected with the moving image contents 185a to 185e and the related term display portion 186 with indicia, such as a line, indicating a relationship between a search term and a search result. The information processing device 100 according to the present embodiment can simultaneously present to the user what kind of moving image content hit for the search term or what kind of word is related to the search term by showing the relevance between the search term, the moving image content in which the relevant search term is contained in the metadata and the word related to the search term.

In FIG. 5, the number of moving image contents displayed on the video output unit 160 and the number of moving image contents being reproduced are displayed in the search term display portion 184 next to the search term input by the user. The information processing device 100 can allow the user to grasp to what extent the moving image content in which the search term is contained in the metadata exists in the storage device 200 and how many moving image contents are being reproduced by displaying on the video output unit 160 in the above manner.

As shown in FIG. 5, the number of moving image contents, in which the respective related term is contained in the metadata, stored in the storage device 200 may be displayed in the related term display portion 186. The information processing device 100 can provide a foothold to a new search with respect to the user by displaying on the video output unit 160 in such a manner. When displaying the number of moving image contents in which the related term is contained in the metadata next to each related term in the related term display portion 186, the search section 112 may execute the search process of the moving image content with each related term as the search term in parallel to the display control section 114 displaying the moving image content on the video output unit 160.

When displaying the moving image contents 185a to 185e that conform to the search term on the video output unit 160 as in FIG. 5, the moving image contents may be displayed with a predetermined frame (e.g., head frame) displayed or may be displayed with each moving image content reproduced at the same time as the display. The display control section 114 may allow processes such as play, pause, and stop independent from each other with respect to each moving image content based on the user operation, or may allow processes such as play, pause, and stop all at once with respect to all the moving image contents.

If the moving image content that conforms to the search term input by the user exists in plurality in the storage device 200, the display control section 114 may lower the resolution of the moving image content and reproduce the same to alleviate the processing load. The display control section 114 may perform the control so that one or two or more moving image contents selected by the user are displayed larger than other moving image contents. In such a case, the display control section 114 may perform the control to display the selected moving image content on the video output unit 160 with a resolution higher than other moving image contents.

The plurality of moving image contents that conform to the search term are simultaneously displayed on the video output unit 160 if the moving image content that conform to the search term input by the user exists in plurality in the storage device 200, but if the number of conforming moving image contents exceeds a predetermined threshold value, the number of moving image contents to simultaneously display on the video output unit 160 may be limited to the relevant threshold value. In such a case, the moving image contents to simultaneously display on the video output unit 160 can be selected according to various conditions. For instance, the moving image content not previewed by the user may be preferentially displayed on the video output unit 160, or the moving image content with more recent save date and time may be preferentially displayed on the video output unit 160.

Furthermore, when displaying the moving image contents 185a to 185e that conform to the search term on the video output unit 160 as in FIG. 5, which audio is being output from which moving image content may not be recognized if the audio is output from all the moving image contents. Therefore, the moving image content to output the audio is desirably limited to only one. For instance, the display control section 114 may control the output of the audio so that the audio is output only from the moving image content on which the mouse cursor 183 is placed with the operation of the user on the operation unit 150.

The display control section 114 may display on the video output unit 160 with the distance of the search term and the moving image content changed according to the level in the relevance between the search term and the moving image content. In other words, the display control section 114 may display the search term and the moving image content close if the relevance between the search term and the moving image content is relatively or absolutely high, and may display the search term and the moving image content apart if the relevance between the search term and the moving image content is relatively or absolutely low. Furthermore, if the moving image content that conforms to the search term input by the user exists in plurality in the storage device 200, the display control section 114 may determine the display position of each moving image content so as not to overlap another moving image content.

When displaying the moving image contents 185a to 185e that conform to the search term on the video output unit 160 as in FIG. 5, the display control section 114 may change the display position of each moving image content by the operation of the user, or may change the display size of each moving image content by the operation of the user. The display control section 114 may also convert the display size of the video content to display on the video output unit 160 according to the level of the relevance degree with the search term and display the video content on the video output unit 160.

FIG. 5 shows that the related term display portion 186 for displaying the word related to the search term input by the user is displayed in the video output unit 160. The user can use the word displayed in the related term display portion 186 to cause the information processing device 100 to execute further search of the moving image content. For instance, if one of the words displayed in the related term display portion 186 is dropped on the screen by the operation of the operation unit 150 by the user, the search section 112 can execute the search of the storage device 200 with the dropped word as the search term, and the display control section 114 can display the search result on the video output unit 160.

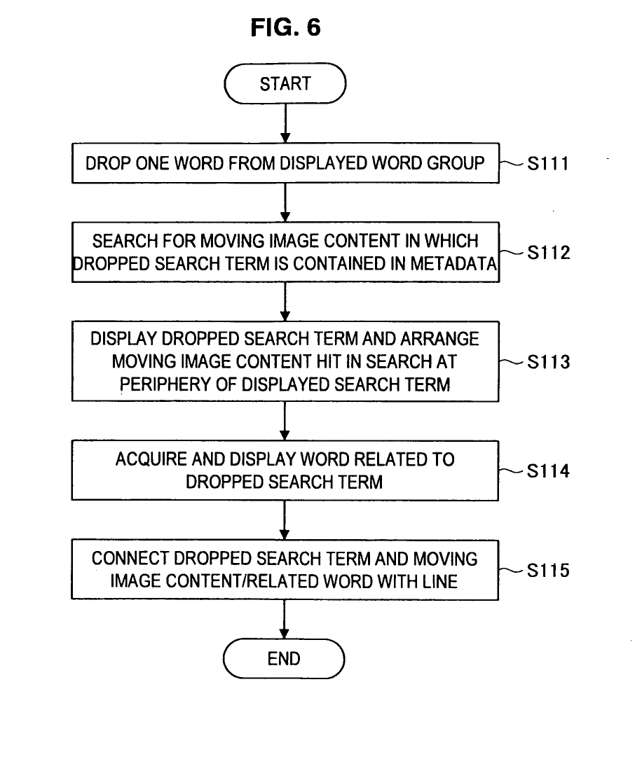

FIG. 6 is a flowchart showing a further search process of the moving image by the word displayed in the related term display portion 186 using the information processing device 100 according to one embodiment of the present invention. The further search process of the moving image content using the information processing device 100 according to one embodiment of the present invention will be described below using FIG. 6.

When the word displayed on the related term display portion 186 is dropped on the screen by the operation of the operation unit 150 by the user with the moving image content and the word related after the search displayed on the video output unit 160 as in FIG. 5 (step S111), the search section 112 searches for the moving image content 210 in which the relevant search term is contained in the metadata 220 from the storage device 200 with the dropped word as the search term (step S112).

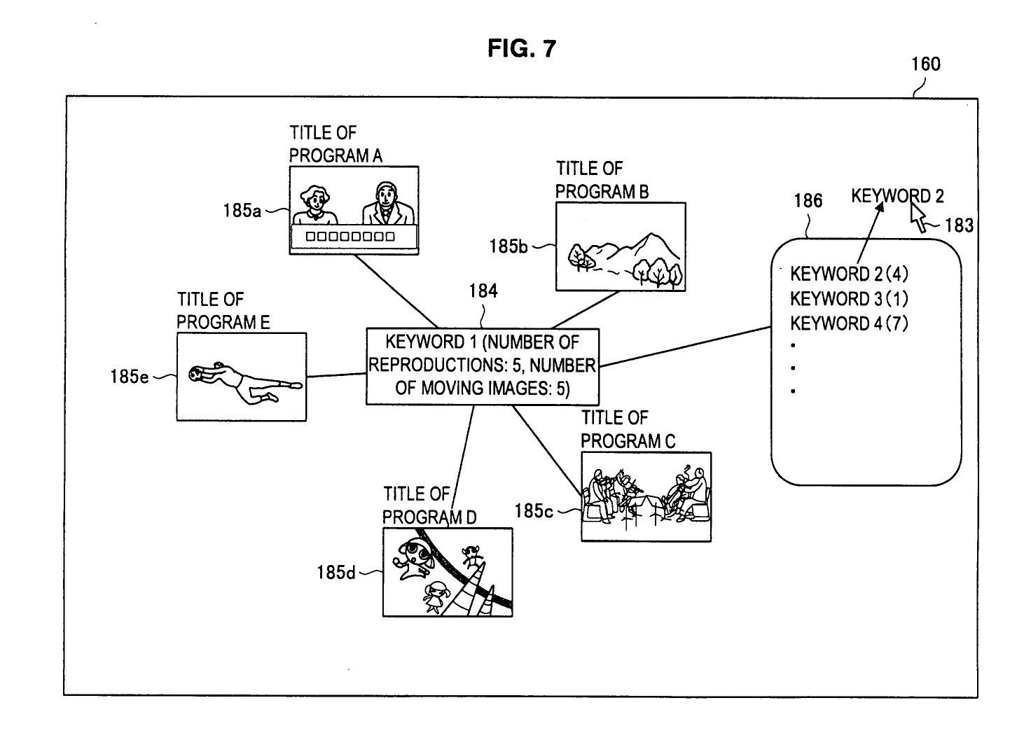

FIG. 7 shows one example of a screen displayed on the video output unit 160. According to FIG. 7, in one example of the screen displayed on the video output unit 160 shown in FIG. 5, a state in which the user operates the operation unit 150 to drag and drop one word from the words displayed in the related term display portion 186 on the screen. In FIG. 7, “keyword 2” is selected and then dragged and dropped on the screen.

When the control unit 110 detects that the “keyword 2” is dragged and dropped on the screen, the search section 112 searches for the moving image content 210 in which the search term is contained in the metadata 220 from the storage device 200 with the dropped “keyword 2” as the search term.

After searching for and extracting the moving image containing the search term from the storage device 200 with the word dropped on the screen as the search term, the control unit 110 displays the search term dropped on the screen on the video output unit 160, and displays the moving image content extracted (hit for the search term) from the storage device 200 on the video output unit 160. More specifically, the display control section 114 controls the display on the video output unit 160 so as to arrange the extracted moving image content at the periphery of the displayed search term (step S113).

Thereafter, the control unit 110 acquires a word related to the search term dropped on the screen from the related term server 300. Specifically, the related term acquiring section 116 accesses the related term server 300, and acquires the word related to the search term dropped on the screen from the related term server 300. The display control section 114 also performs the control to display the word acquired from the related term server 300 on the video output unit 160 (step S114).

The display control section 114 then connects the search term displayed on the video output unit 160 in step S113, the moving image content displayed on the video output unit 160 in step 5113 and the word displayed on the video output unit 160 in step S114 with a line, and displays the same on the video output unit 160 (Step S115). Therefore, the information processing device 100 can directly display the moving image content on the video output unit 160 without the search result screen of the moving image content. Furthermore, the information processing device 100 can visually show the user the relationship with the moving image content that hit for the search term and the word related to such search term by displaying the search term dropped on the screen from the related term display portion 186 by the user, the moving image content in which the search term is contained in the metadata and the word related to the search term input by the user on the video output unit 160. The information processing device 100 can also enhance the operability of the user by enabling a new search using the word displayed in the related term display portion 186.

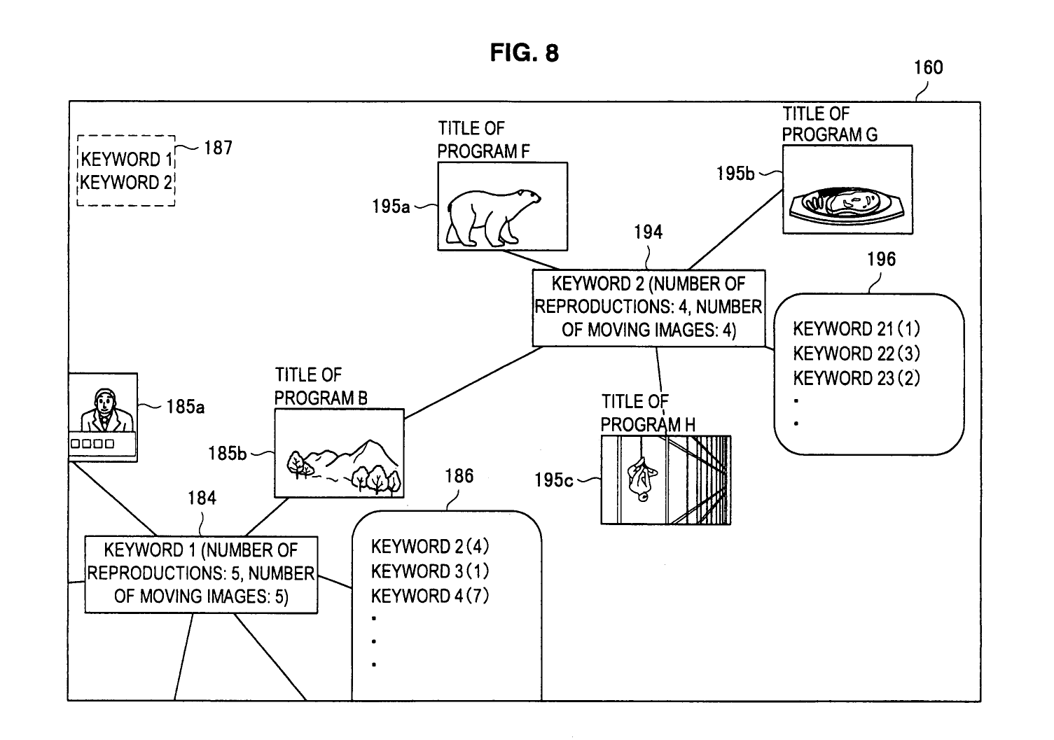

FIG. 8 shows one example of a screen displayed on the video output unit 160. FIG. 8 shows a display example of the search result of when the moving image content stored in the storage device 200 is searched using the word displayed in the related term display portion 186 from the state displayed in the video output unit 160 as in FIG. 5.

In the example shown in FIG. 8, a search term display portion 194 for displaying the search term dropped on the screen from the related term display portion 186 by the user, moving image contents 195a to 195c that conform to the search term dropped on the screen from the related term display portion 186 by the user, and a related term display portion 196 for displaying a word related to the search term dropped on the screen from the related term display portion 186 by the user are displayed on the video output unit 160. If the moving image content that conforms to the search term dropped on the screen from the related term display portion 186 by the user exists in plurality in the storage device 200, the information processing device 100 simultaneously displays the plurality of moving image contents that conform to the search term on the video output unit 160 as shown in FIG. 8.

As shown in FIG. 8, the search term display portion 194 displayed on the video output unit 160 is connected with the moving image contents 195a to 195c and the related term display portion 196 with a line. The information processing device 100 according to the present embodiment can simultaneously present to the user what kind of moving image content hit for the search term or what kind of word is related to the search term by showing the relevance between the search term and, the moving image content in which the relevant search term is contained in the metadata and the word related to the search term. Furthermore, as shown in FIG. 8, the moving image content 185b is connected with both the keyword 1 and the keyword 2 with a line, so that the user can grasp in one glance that it is the moving image content hit for both search terms.

In one embodiment, the information processing device 100 may display, on a display screen, the word related to the search term at a different depth than the search term and/or the search result obtained for the search term.

In another embodiment, the information processing device 100 may display, on a display screen, indicia, such as using a marking, color, size, resolution or the like, to indicate relevance or a relationship between a search result obtained for a search term and another search result, such as an additional search result obtained for the search term or a search result obtained for a word related to the search term.

The information processing device 100 according to the present embodiment does not erase the word displayed in the search term display portion 184 from the screen and enable the relevant word to be used as a new search term, so that the user can continuously carry out the search of the moving image content on the same screen.

If the moving image content that conform to a plurality of search terms exists, the display control section 114 may display the same moving image content in an overlapping manner on the video output unit 160, but only one moving image content may be displayed to facilitate the understanding of the relevance between the search terms, where the relevance may be made apparent by drawing a plurality of lines connecting the moving image content and the search term.

In the example shown in FIG. 8, the moving image content 185b is the moving image content in which both the “keyword 1” and the “keyword 2” are contained in the metadata. Therefore, the moving image content 185b is connected to both the search term display portion 184 displaying the “keyword 1” and the search term display portion 194 displaying the “keyword 2” with a line. Therefore, the information processing device 100 according to the present embodiment can visually present the relevance between the search terms by displaying the relevance between the search terms through the moving image content.

If the search process of the moving image content by the search section 112 is continuously executed, the display control section 114 may display the search history on the video output unit 160. FIG. 8 illustrates a search history display portion 187. The search history display portion 187 displays the search terms in a line in the order of oldest to newest search history from the top. It should be recognized that the display form of the search history is not limited to that shown in FIG. 8.

Therefore, the information processing device 100 according to the present embodiment can execute the search process of the new moving image content using the word displayed in the related term display portion 186, but may also display a search term input box and execute the search process of the new moving image content with the search result displayed on the video output unit 160.

As shown in FIG. 8, the moving image content search application displayed on the video output unit 160 by the information processing device 100 according to the present embodiment may be displayed such that the screen can be scrolled if the search results are not able to be displayed in one screen. The relevant moving image content search application can display a great number of moving image contents on the video output unit 160 all at once by displaying the search results in a scrollable manner.

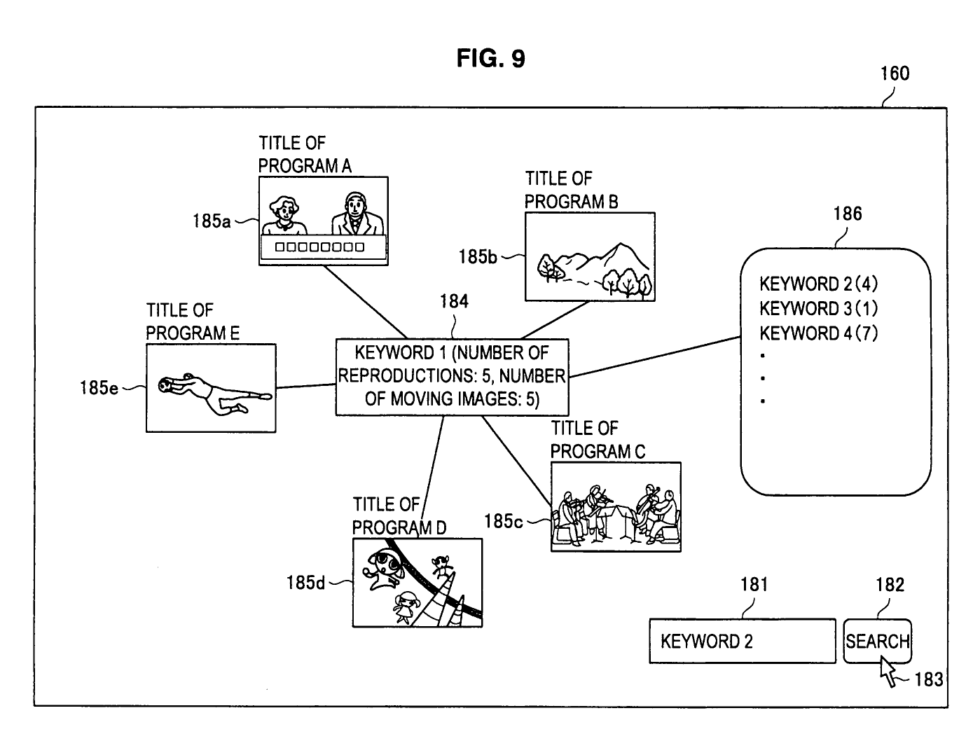

FIG. 9 shows one example of a screen displayed on the video output unit 160. In FIG. 9, a state in which the search term input box 181 and the search button 182 are displayed on the video output unit 160 based on the operation of the operation unit 150 by the user is illustrated in one example of the screen displayed on the video output unit 160 shown in FIG. 5. When the search term is input to the search term input box 181 by the user and the search button 182 is pushed by the user with the screen as shown in FIG. 9 displayed on the video output unit 160, the search process starts and the moving image contents are newly radially developed at the periphery of the search term separately with the search term input to the search term input box 181 as the center. In this case, if the moving image content also related to the search term that is already input exists, such moving image content is connected from both search terms with a line, so that the user can grasp in one glance that it is the moving image content hit for both search terms.

The user can input the search term to the search term input box 181 by displaying the search term input box 181 and the search button 182 on the video output unit 160 as shown in FIG. 9. When the user inputs the search term to the search term input box 181 and pushes the search button 182, the search section 112 searches for the moving image content, in which the search term input to the search term input box 181 is contained in the metadata, from the storage device 200, and the display control section 114 displays the moving image content searched by the search section 112 on the video output unit 160. In parallel to the search process of the moving image content, the related term acquiring section 116 acquires the word related to the search term input to the search term input box 181 from the related term server 300, and the display control section 114 displays the word acquired by the related term acquiring section 116 on the video output unit 160. The process similar to that described above is executed for the displaying process of the search term input to the search term input box 181, the searched moving image content, and the word from the related term server 300 by the display control section 114.

One example of the reproduction process of the moving image content displayed on the video output unit 160 in the above manner will now be described. The search term input to the search term input box 181 by the user or the word dropped on the screen from the related term display portion 186 is information the user desires to see or know. Therefore, the convenience of the user in time of viewing of the moving image content enhances if reproduced from the scene containing such search term/word.

In order to reproduce the moving image content in such a manner, the search section 112 searches for the caption data and extracts the area containing the word input or selected by the user, and the display control section 114 performs the control to reproduce the moving image content from the scene corresponding to the area extracted by the search section 112.

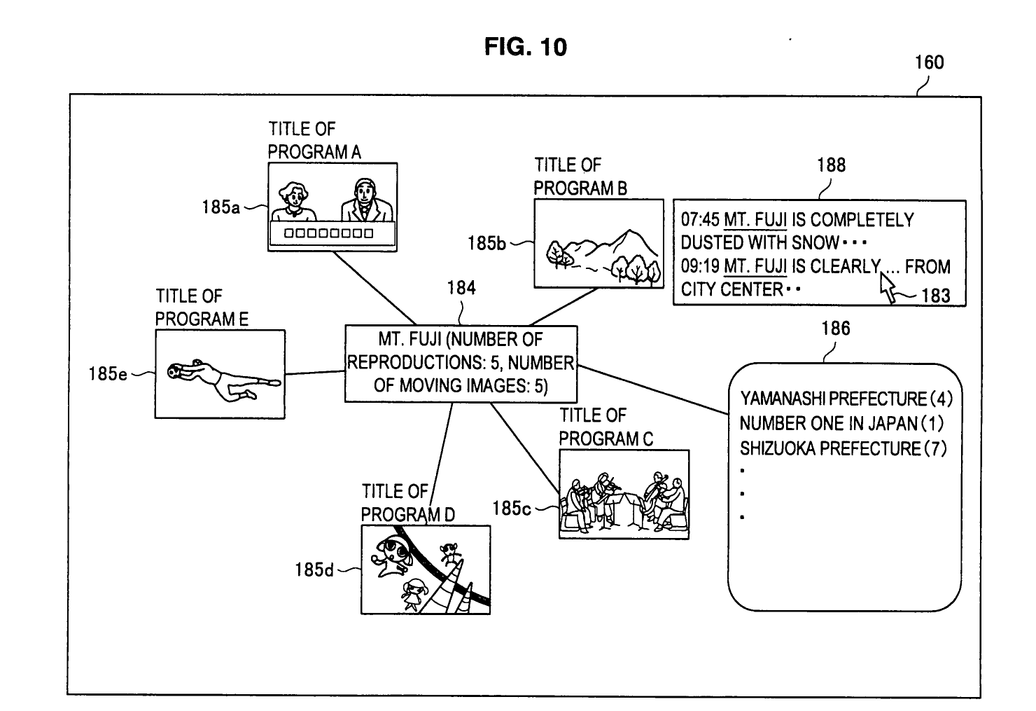

FIG. 10 shows one example of a screen displayed on the video output unit 160. In FIG. 10, a case in which the mouse cursor 183 is placed on one moving image content (moving image content 185b herein) with the search result of the moving image content displayed on the video output unit 160 is shown.

FIG. 10 is an example of a screen displayed on the video output unit 160 when the user inputs “Mt. Fuji” for the search term and searches for the moving image content in which “Mt. Fuji” is contained in the metadata with the search section 112. When the user places the mouse cursor 183 on the moving image content 185b with the video output unit 160 displaying the above, the display control section 114 displays a caption data display portion 188 in the vicinity of the moving image content 185b (on the right in the example shown in FIG. 10). The caption data display portion 188 displays the caption data containing the search term along with the location where the search term is contained (time from the head of the moving image content). In FIG. 10, the user inputs “Mt. Fuji” for the search term, and thus the caption data of the area containing “Mr. Fuji” is displayed in the caption data display portion 188 along with the time from the head of the moving image content of the relevant area if “Mt. Fuji” is contained in the caption data. When the user selects (e.g., clicks with the mouse) the caption data displayed in the caption data display portion 188, the display control section 114 reproduces the moving image content 185b from the scene corresponding to the caption data selected by the user.

Therefore, the information processing device 100 according to the present embodiment can present to the user why the relevant moving image content is extracted and the user can recognize why the relevant moving image content hit in the search by displaying the caption data containing the search term on the video output unit 160.

Another example of a screen displayed on the video output unit 160 will now be described. The information processing device 100 according to the present embodiment may execute the search process of the moving image content stored in the storage device 200 using information other than the search term input by the user. For instance, the information processing device 100 may execute the search of the moving image content belonging to a predetermined category, the search of the moving image content using a keyword that is a popular topic on the Internet (e.g., number of searches is recently suddenly rising in the search site on the Internet), and the like.

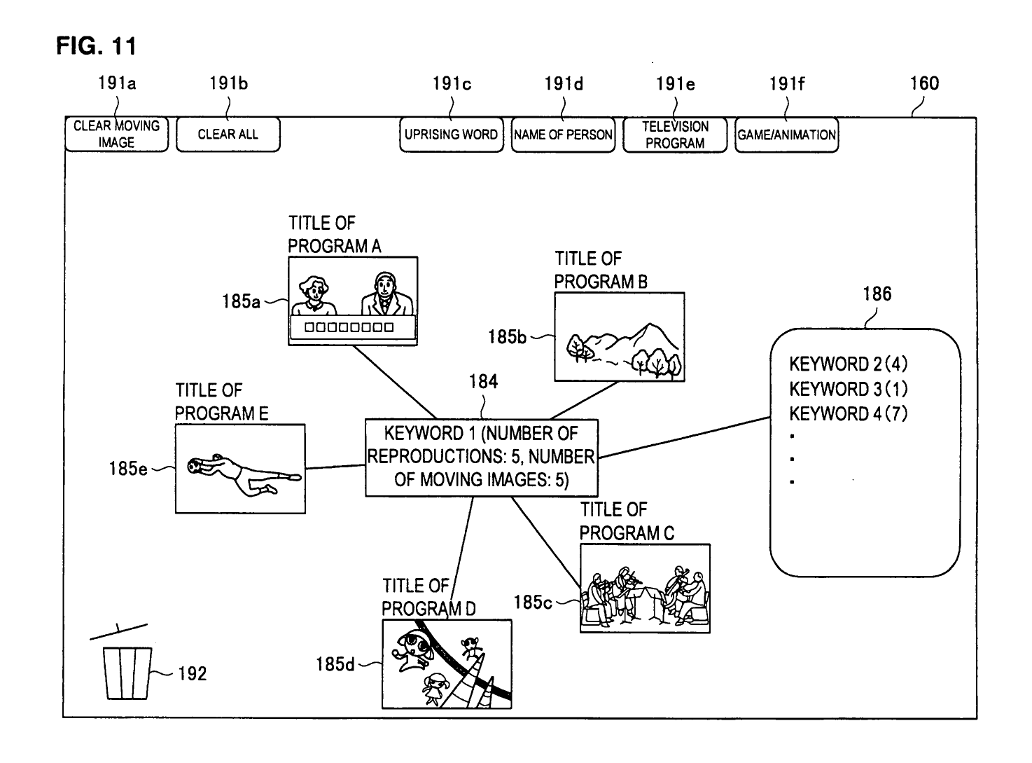

FIG. 11 shows one example of a screen displayed on the video output unit 160. FIG. 11 shows a state in which a button for searching the moving image content stored in the storage device 200 or erasing the moving image content displayed on the video output unit 160 from the screen is displayed on the video output unit 160.

FIG. 11 illustrates an erase button 191a for erasing the moving image content being reproduced from the screen, and an all erase button 191b for erasing all moving image contents from the screen. Furthermore, FIG. 11 illustrates search buttons 191c to 191f for executing the search of a moving image content using a specific category or a keyword that is a popular topic on the Internet. The user of the information processing device 100 pushes the search buttons 191c to 191f to cause the information processing device 100 to execute the search of the moving image content using a specific category or a keyword that is a popular topic on the Internet.

FIG. 11 also illustrates a trash icon 192 for erasing the moving image content displayed on the video output unit 160 from the screen. When the user of the information processing device 100 clicks the moving image content displayed on the video output unit 160 with the mouse and drags the same on the screen and drops the relevant moving image content on the trash icon 192, the display control section 114 erases the relevant moving image content from the screen. Thus, the information processing device 100 can freely move the moving image content displayed on the video output unit 160 on the screen, and can also erase the moving image content from the screen. If the display position of the moving image content is moved to overlap another moving image content by the operation of the user, the display control section 114 may move the display position of the another moving image content so as not to overlap the moving image content being operated by the user. When moving the display position of another moving image content, the display control section 114 desirably moves the moving image content so that the path of movement is apparent.

In each example described above, the relationship between the moving images is displayed through a word as shown in FIG. 8, for example. However, it goes without saying that the present invention is not limited to such an example, and the information processing device 100 may display the moving image content on the video output unit 160 so as to directly express the connection between the moving image contents.

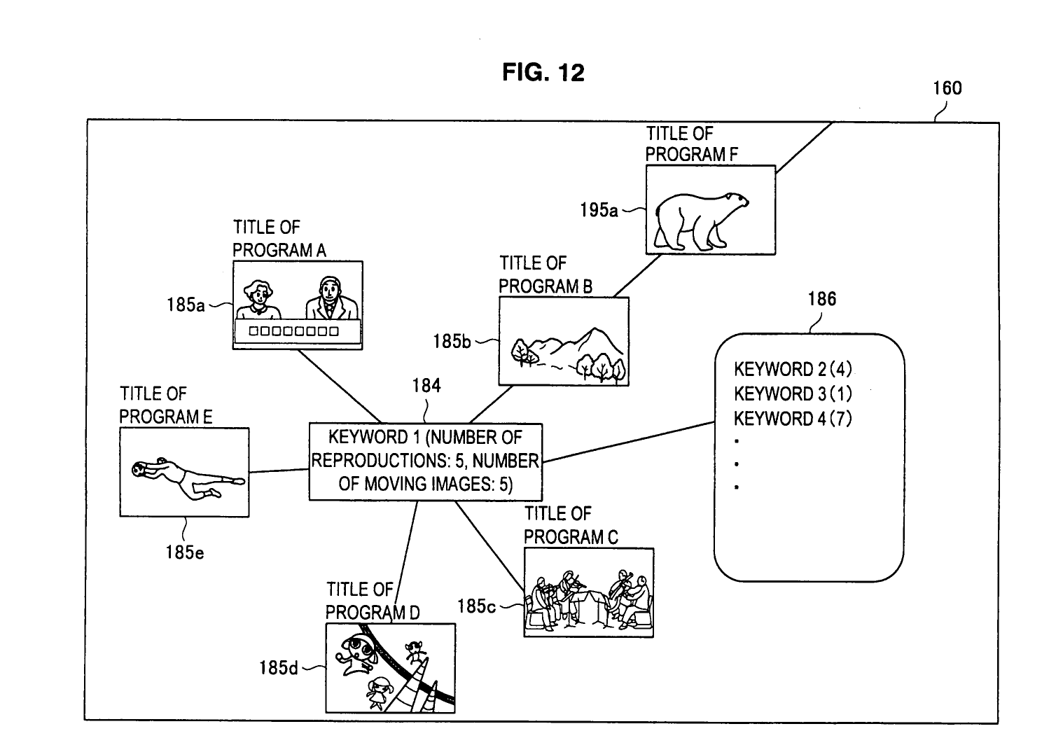

FIG. 12 shows one example of a screen displayed on the video output unit 160. In FIG. 12, a state in which the moving image content is displayed on the video output unit 160 so as to directly express the connection between the moving image contents is illustrated. For instance, when displaying that which hit for the same search term and which has a close relevance in the moving image content itself as with a serial drama, the moving image content is displayed on the video output unit 160 as shown in FIG. 12.

The moving image content 185b and the moving image content 195a are directly connected with a line and displayed on the video output unit 160 shown in FIG. 12. Thus, the information processing device 100 according to the present embodiment can directly indicate the relevance between the moving image content 185b and the moving image content 195a.

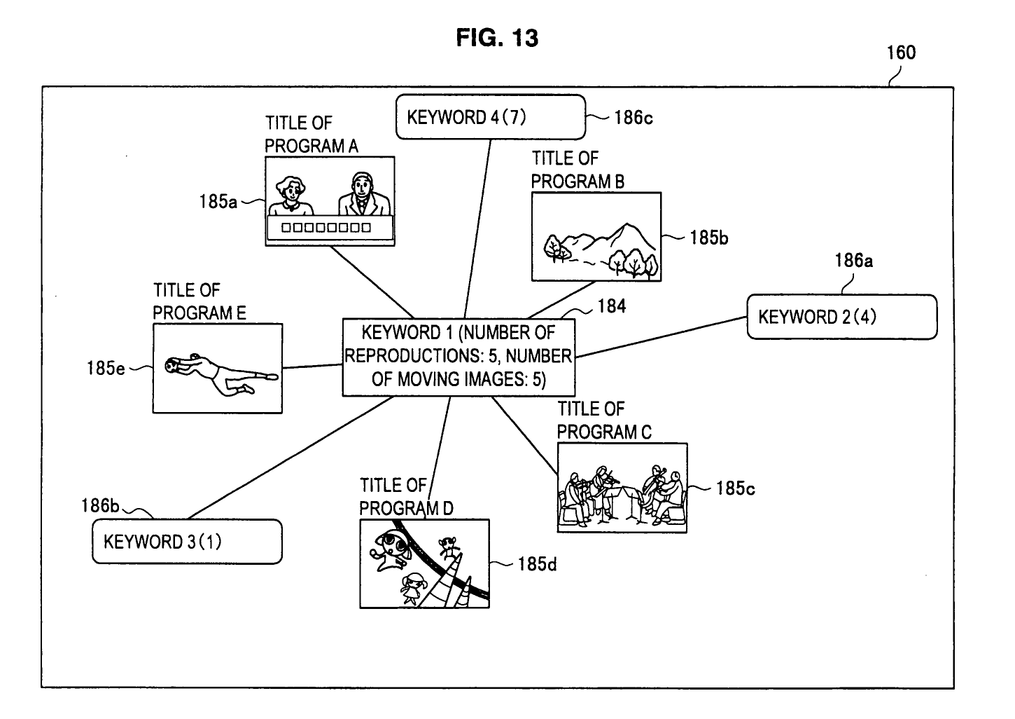

FIG. 13 shows one example of a screen displayed on the video output unit 160. In the example shown in FIG. 13, the moving image content and the search term are radially developed at the periphery of the search term and displayed on the video output unit 160 when the search process by the search section 112 is carried out. FIG. 13 illustrates a state in which the moving image contents 185a to 185e and the related term display portions 186a to 186c are displayed on the video output unit 160.

### 2. Conclusion

As described above, the information processing device 100 according to one embodiment of the present invention extracts the moving image content in which the search term input by the user is contained in the metadata, and displays the extracted moving image content on the screen when searching for the moving image content stored in the storage device 200. When displaying the search result of the moving image content on the screen, the information processing device 100 displays the same so that the relevance with the search term input by the user is visually apparent.

Therefore, the information processing device 100 according to one embodiment of the present invention can provide the user an efficient preview of the moving image content by displaying on the screen so that the relevance between the search term input by the user and the search result of the moving image content is visually apparent.

When displaying the search result of the moving image content, the information processing device 100 according to one embodiment of the present invention externally acquires a word related to the search term input by the user and similarly displays on the screen so that the relevance with the search term is visually apparent. In this manner, which word related to the search term can be provided and the search of further moving image content using the relevant related word as the search term can be provided to the user by displaying the search term input by the user and the word related to such a search term on the screen.

According to one embodiment of the present invention, the related term related to the search term is appropriately arranged in a browsing region of the moving image content or the search result so as to get the attention of the user at the same time as the moving image content. The way of enjoying the moving image of further proceeding with the search from the related term that got the attention of the user can be provided to the user by having the user recognize with the moving image content and the search term arranged on the screen in the above manner.

In particular, if the search term is three or more, a complicated relevance between each of the moving image contents and the search term can be viewed on the screen. In other words, the relationship such as a moving image content group related to a keyword A and a keyword B and a moving image content group related only to a keyword C, the relationship of a moving image content group related only to each of the keyword A, the keyword B, and the keyword C, and the like are generated, and the user can recognize each relationship in one view. Therefore, a browsing method different from uniformly browsing the search result corresponding to the search term as in the search of the moving image content of the related art can be provided. In other words, the user can search for the desired content while looking at the connection degree of the search term and the moving image content developed on the screen.

When executing the search process of the moving image content with the information processing device 100 according to one embodiment of the present invention, the user of the information processing device 100 may input a sentence rather than a word in the search term input box 181. In such a case, the search section 112 may extract a word that may become the search term from the input sentence, and execute the search process of the moving image content stored in the storage device 200 with the relevant word as the search term. When the search section 112 extracts a plurality of words that may become the search term, the search section 112 may execute the search process of the moving image content having the plurality of words as the search term, and the display control section 114 may display the search result by the plurality of search terms all at once on the video output unit 160. Furthermore, with respect to the moving image content in which the plurality of search terms are contained in the metadata, the display control section 114 may display so that the relevance between the plurality of search terms and the moving image content is apparent such as by connecting the plurality of search terms and the moving image content with a line as shown in FIG. 8.

In the embodiment described above, the moving image content 210, the metadata 220, and the search index 230 are stored in the storage device 200, which is a different device from the information processing device 100, but as described above, the moving image content 210, the metadata 220, and the search index 230 may be stored in the same device as the information processing device 100 in the present invention. Furthermore, in the present invention, the moving image content 210, the metadata 220, and the search index 230 may be saved in a server device connected to the information processing device 100 through the network 10. In this case, the server device may not include the operation unit 150, the video output unit 160, and the audio output unit 165 shown in FIG. 2, the information processing device that executes the search process of the moving image content may not include the digital TV tuner 140, and the moving image content 210, the metadata 220, and the search index 230 may not be saved in the relevant information processing device.

In the above-described embodiment, the search section 112, the display control section 114, and the related term acquiring section 116 are arranged inside the information processing device 100, but the present invention is not limited to such example. For instance, the search section 112, the display control section 114, and the related term acquiring section 116 may be arranged in the server device connected to the information processing device 100 through the network 10 or with the LAN etc., where the search process of the moving image content may be carried out in the server device when the information processing device 100 is connected to the server device. With such a configuration, the search process of the moving image content by connecting to the server device from a plurality of information processing devices 100 becomes possible.

In the above-described embodiment, the search target in the search process executed by the information processing device 100 is the moving image content stored in the storage device 200, but the search target in the search process executed by the information processing device 100 is not limited to the moving image content in the present invention. For instance, the search target in the search process executed by the information processing device 100 may be a music content stored in the storage device 200.

When having the music content as the search target, the singer or the band name, the era, the category, the lyrics, the musical composition analysis result, and the like may be stored in the storage device 200 as the metadata of each music content. When executing the search process as described above, the information processing device 100 may extract the music content in which the search term is contained in the metadata, and similarly display the same at the periphery of the search term. The information processing device 100 can visually show the relationship between the search term and the music content by searching for the music content and displaying the search result in the above manner.

It should be understood by those skilled in the art that various modifications, combinations, sub-combinations and alterations may occur depending on design requirements and other factors insofar as they are within the scope of the appended claims or the equivalents thereof.

For instance, in the above-described embodiment, the search term and the moving image content are connected with a line and displayed when the display control section 114 displays the search result of the moving image content on the video output unit 160, but the present invention is not limited to such an example. For instance, the display control section 114 may surround the search term and the moving image content with the same frame and display the same, or may give the search term and the moving image content with the frame of same color and display the same. Furthermore, if the distance of the search term and the moving image content is spaced apart by greater than or equal to a predetermined distance, the display control section 114 may display so as to connect the moving image content and the search term with a line.

For instance, when the display control section 114 displays the search result of the moving image content on the video output unit 160, the moving image content having a relevance degree with the search term relatively higher than other moving image contents may be displayed close to the search term, and the moving image content having a relevance degree with the search term relatively lower than other moving image contents may be displayed distant from the search term. The level of the relevance degree with the search term may be determined by the number of times the relevant search term appeared in the metadata, or may be determined by whether or not the area where the relevant search term appeared in the caption data is gathered together temporally close.

Furthermore, the display control section 114 may display one moving image content selected from the moving image contents that conform to the search term by switching from the screen shown in FIG. 5 to another screen. When switching from the screen shown in FIG. 5 to another screen, the display control section 114 may perform the control to display the moving image content large on the video output unit 160.

The information processing device 100 may record the arrangement information of the search term displayed on the video output unit 160 by the display control section 114 in the memory 120 or the HDD 170. Similar search then can be executed on the newly added moving image content by again calling out the arrangement information of the search term after the search of the moving image content is once finished.

That is, a map (keyword map) of the keyword of interest can be completed by freely arranging the word of interest by the user of the information processing device 100 on the screen in time of the search process of the moving image content. The finished keyword map is saved in the memory 120 or the HDD 170. When the saved keyword map is called out one week later, the moving image content broadcasted and recorded during the one week can be displayed with an interface in which the relevance between the search term and the moving image content is visualized, as described above.

In each of the embodiments described above, the steps described in the flowchart obviously include processes performed in time-series along the described order, but also include processes executed in parallel or individually even if not processed in time-series. Furthermore, it should be recognized that the order of steps processed in time-series can be appropriately changed according to circumstances.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a display control unit to control display on a display screen, around a search term, of a search result obtained from searching using the search term and at least one term related to the search term.

2. The device of claim 1, wherein, when a first related term from the at least one related term is selected, the display control unit controls displays on the display screen, around the first related term, of another search result obtained from searching using the first related term, with at least one of the search term and the search result.

3. The device of claim 2, wherein the another search result is displayed at a different depth than the at least one of the search term and the search result.

4. The device of claim 2, wherein the display control unit is to control display on the display screen of indicia indicating relevance between the search result and the another search result.

5. The device of claim 1, wherein the search result includes a plurality of search results.

6. The device of claim 1, wherein the display control unit is to control display on the display screen of indicia indicating a relationship between the search result and the search term.

7. The device of claim 6, wherein the indicia is a line extending between the search result and the search term.

8. The device of claim 6, wherein the indicia is at the search result or the search term.

9. The device of claim 1, wherein the search result is displayed at a position on the display screen determined based on relevance with respect to the search term.

10. The device of claim 1, wherein the search result is displayed at a position on the display screen determined based on a position of another search result displayed on the display screen with the search result.

11. The device of claim 1, wherein, when a search result among a plurality of search results displayed on the display screen is selected, the selected search result is displayed differently than other of the plurality of search results.

12. The device of claim 11, wherein the selected search result is displayed larger than the other of the plurality of search results.

13. The device of claim 11, wherein the selected search result is displayed with a higher resolution than the other of the plurality of search results.

14. The device of claim 1, wherein, when a first related term from the at least one related term is selected, the display control unit controls display on the display screen, with the search result, of a search history display portion including the first related term.

15. The device of claim 1, wherein, when a cursor is on the search result, the display control unit controls display on the display screen, with the search result, of a display portion including the search term and an indication of a location of the search term within the search result.

16. The device of claim 15, wherein the search result is moving image content and the indication of the location of the search term is a time from a head of the moving image content.

17. The device of claim 16, wherein, when the display portion is selected, the display control unit controls reproduction on the display screen of the moving image content from a scene corresponding to the time.

18. The device of claim 1, wherein, when the search result is selected, the search result is movable on the display screen.

19. A method of information processing comprising:
searching using a search term to obtain a search result; and
controlling, by a processor, display on a display screen, around the search term, of the search result and at least one term related to the search term.

20. A non-transitory recording medium recorded with a computer-readable program executable by a computer for enabling the computer to perform information processing, the program comprising the steps of:
searching using a search term to obtain a search result; and
controlling display on a display screen, around the search term, of the search result and at least one term related to the search term.
